(19) United States
(12) Patent Application Publication
(10) Pub. No.: US 2025/0298726 A1
(43) Pub. Date: Sep. 25, 2025

(54) TEST METHOD AND SYSTEM BASED ON COMBINATION FUNCTION COVERAGE

(71) Applicant: JINAN XINYU SOFTWARE TECHNOLOGY CO., LTD., Jinan, Shandong (CN)

(72) Inventors: Min Yi, Jinan, Shandong (CN); Ming Wei, Jinan, Shandong (CN); Min Cheng, Jinan, Shandong (CN); Yunzhao Yang, Jinan, Shandong (CN); Chuanqiang Shen, Jinan, Shandong (CN); Tianhao Yi, Jinan, Shandong (CN)

(21) Appl. No.: 18/726,394

(22) PCT Filed: Apr. 13, 2023
(86) PCT No.: PCT/CN2023/088071

§ 371 Date: Apr. 30, 2025

(30) Foreign Application Priority Data
Sep. 8, 2022 (CN) 202211093127.3

(51) Int. Cl. G06F 11/3668

(52) U.S. Cl. CPC G06F 11/3676

(57) ABSTRACT

A test method and system based on a combination function coverage are provided, where the method includes: constructing a combination function coverage based on a verification requirement, and directly using the combination function coverage as a random constraint to generate a random excitation; setting a random seed for a value range of each variable in the combination function coverage structure; generating a value segment combination sequentially or randomly based on a total quantity of scenarios in the combination function coverage structure; generating a corresponding random excitation based on the generated value segment combination and a corresponding random seed, to perform testing in a current scenario; and repeatedly perform random excitation generation and scenario testing until testing in all scenarios is completed. Definition of a function coverage is directly used as a random constraint, so that a programming workload is greatly reduced.

### CROSS-REFERENCE TO RELATED APPLICATION

This application claims the benefit of Chinese Patent Application No. 202211093127.3, filed on Sep. 8, 2022, which is hereby incorporated by reference in its entirety including any tables, figures, or drawings.

### TECHNICAL FIELD

The present disclosure relates to the technical fields such as chip verification and software testing, and specifically, to a test method and system based on a combination function coverage.

### BACKGROUND

In chip verification, to ensure chip quality, a large amount of scenario analysis needs to be performed, so that various scenarios can be covered, to help quantify statistics about achievement of a coverage. This coverage is defined as a function coverage (Function Coverage).

After the function coverage is defined, a random test (Random Test) method and a direct/directional test (Direct Test) method are used to collect statistics about a function coverage of the random data, so as to obtain a coverage result.

Existing test technologies based on the function coverage mainly include the following two types:

In a conventional technology 1, for example, a simple scenario is determined by two variable factors x and y, and is defined by using the System Verilog language. A combination function coverage (cross coverage) is defined by using a covergroup-coverpoint-bins-cross syntax structure. Code is as follows:

```
covergroup cg (ref rand_data inst);
a: coverpoint inst.x
{
    bins a1 = { [0:63] };
    bins a2 = { [64:127] };
    bins a3 = { [128:191] };
    bins a4 = { [192:255] };
}
b: coverpoint inst.y
{
    bins b1 = { 0 };
    bins b2 = { [1:84] };
    bins b3 = { [85:169] };
    bins b4 = { [170:255] };
    option.weight = 2;
  }
  c: cross inst. x, inst. y;
endgroup
```

The parameter inst in cg (ref rand_data inst) is an instance of a “random dataset”, and this “random dataset” is defined later. Theoretical value ranges of the variables x and y are 0 to 255. To define a combination coverage of these two variables, a coverage group (covergroup) cg needs to be first defined. Then, two coverage points (coverpoints) a and b are defined inside the coverage group, to respectively correspond to the variables x and y. Next, a plurality of coverage bins (bins) are separately defined for the coverage points a and b. A combination coverage (cross) is defined, to correspond to the variables x and y. The coverage bins of the coverage points a and b are used for combination, to define a total of 16 combinations that need to be covered.

The statement option.weight=2 is used to set a weight, to collect statistics about the function coverage.

To cover the foregoing combinations, a random constraint is used, and code is as follows:

class rand_data;
rand bit[7:0] x;
rand bit[7:0] y;
constraint x_c
{
x inside {[0:63], [64:127], [128:191], [192:255]};
}
constraint y_c
{
y inside {0, [1:84], [85:169], [170:255]};
}
endclass

After the foregoing definition is made, a random object_inst and a combination coverage object cg_inst are instantiated. The random object rand_inst invokes a randomize( ) function to generate a group of random data. The combination coverage object cg_inst invokes a sample( ) function to complete collection of combination coverage data. Code is as follows:

```
module test;
  rand_data rand_inst = new( );
  cg cg_inst = new(rand_inst);
  initial begin
    repeat (16) begin
      rand_inst. randomize( );
      cg_inst. sample( );
    end
  end
endmodule
```

It may be learned from the foregoing analysis that the conventional technology mainly includes: defining a combination function coverage target, defining a random constraint to generate a corresponding random excitation, and collecting random data, to obtain function coverage data.

In a conventional technology 2, a coverage object (object) that needs to be tested is first defined, to correspond to the coverpoint in the conventional technology 1. Then, a combination testcase of the object is defined, to correspond to the covergroup in the conventional technology 1. Finally, coverage of the testcase is implemented by using a keep constraint, to correspond to the constraint in the conventional technology 1. In the conventional technology 2, the combination coverage target (covergroup) and the random constraint (constraint) are still separately defined and implemented. In the conventional technology 2, definition of the random constraint is mainly improved. A definition manner of the random constraint is directly repeated with definition of the covergroup combination coverage target. In addition, to improve test efficiency, an orthogonal random excitation generation method is provided. An orthogonal table is used as a basis. Based on a shape (which is determined by a length of each object) of a cross combination and by using a “lookup algorithm”, an “increment algorithm”, and a “combining algorithm”, an orthogonal factor in the combination is found and preferentially generated as a target to be preferentially covered, and a highest coverage weight is assigned to the factor. Another factor is randomly generated as a secondary coverage target.

It is well known that the function coverage and the random constraint are two independent systems. The function coverage defines only a target, and the random constraint is responsible for implementing the function coverage target. The function coverage and the random constraint are not associated with each other in a closed loop, and the function coverage target needs to be implemented by manually applying the random constraint through a large amount of programming. Therefore, in the conventional technology, the covergroup defines the combination coverage target, and the constraint random constraint (keep random constraint) is a means of implementing the target. When the covergroup and the constraint are separately defined and implemented, the following disadvantages exist:

(1) Steps of defining the function coverage by using covergroup-coverpoint-bins are complex. To meet a requirement of a compiler, a large amount of additional information is input, an effective information density is low, and a programming workload is large.

(2) The weight (weight) is set only for the covergroup, the coverpoint, and the cross, and is only used to calculate coverage data. The weight cannot be set for the bins. As a result, weight setting does not really achieve a verification purpose.

(3) Definition of the function coverage and the random constraint are separate, and are not associated with each other. To implement the combination coverage defined by the coverage covergroup, a complex constraint random constraint needs to be defined, such as a set, weight definition (which is basically repeated definition of coverpoint-bins), an expression (using relational operators >, >=, <, <=, ==), and a conditional constraint (if . . . else). This causes a large programming workload.

(4) There is no combination constraint for a plurality of random variables, and the combination constraint for the plurality of variables can be implemented only through programming by using complex syntax. As a result, a complete hit cannot be implemented, and simulation verification time needs to be increased, causing low test efficiency. Even if the constraints of the variables x and y are defined exactly in consistent with the combination coverage, 16 combinations of the variables x and y cannot be completely hit. In common cases, some combinations are repeatedly hit, and some combinations are never hit. An improvement is to increase a quantity of times of generating the random excitation (increase a repetition quantity from 16 to 32) or change a random number seed. This undoubtedly increases simulation verification time. Even if the foregoing improvement is made, it cannot be ensured that all the combinations can be completely hit. However, in the conventional technology 2, to improve efficiency, the definition manner of the random constraint and the random test algorithm are improved. However, a 100% coverage still cannot be reached.

### SUMMARY

To resolve a problem such as a large programming workload, low test efficiency, and the like in an existing function coverage test technology, the present disclosure provides a test method based on a combination function coverage. In the present disclosure, definition of a function coverage is directly used as a random constraint, so that the random constraint and the function coverage are no longer independent systems, which reduces coding work related to application of the random constraint, and greatly reduces a programming workload. In addition, with reference to a random test algorithm, a function coverage target can be quickly implemented.

The present disclosure is implemented by the following technical solutions:

A test method based on a combination function coverage includes:
constructing a combination function coverage based on a verification requirement, and directly using the combination function coverage as a random constraint to generate a random excitation;
setting a random seed for a value range of each variable in the combination function coverage structure;
generating a value segment combination sequentially or randomly based on a total quantity of scenarios in the combination function coverage structure;
generating a corresponding random excitation based on the generated value segment combination and a corresponding random seed, to perform testing in a current scenario; and
determining whether testing in all scenarios in the combination function coverage structure is completed, and if testing in all the scenarios in the combination function coverage structure is not completed, returning to the step of generating a value segment combination sequentially or randomly based on a total quantity of scenarios in the combination function coverage structure.

In some embodiments, the constructed combination function coverage structure is a nested three-level structure in which a first level, a second level, and a third level are sequentially arranged from the outside to the inside;
curly brackets “{ }” are used at the first level to indicate related internal variables and a combination of the variables;
square brackets “[ ]” are used at the second level to indicate all value segments of each variable; and
square brackets “[ ]” are used at the third level to indicate a value range of each value segment.

In some embodiments, the first level includes at least one variable.

In some embodiments, the value range of each value segment includes two types, one type is a single numerical value, that is, upper and lower limits of the value range are a same value, and the other type is a value range using upper and lower limits, that is, the upper and lower limits of the value range are different values.

In some embodiments, when the value range is a single numerical value, the square brackets “[ ]” are omitted.

In some embodiments, the third level further includes “*weight” added after the square brackets “[ ]” of each value range, weight represents a weight, and the weight is used to represent a repetition quantity of a value corresponding to the value range.

In some embodiments, the generating a value segment combination sequentially or randomly based on a total quantity of scenarios in the combination function coverage structure is specifically as follows:
a total quantity of scenarios in a combination function coverage structure is N=N₁*N₂* . . . *Nn, n represents a quantity of variables, and Nᵢ (i=1, 2, . . . , n) represents a quantity of value segments of an i^{th} variable; and
if a value segment combination is generated sequentially, combination is performed sequentially based on the quantity N of scenarios, and when a weight is encountered, repetition is performed based on the weight; or
if a value segment combination is generated randomly, N value segment combinations that cover all scenarios in the combination function coverage structure are first generated based on the quantity N of scenarios, then a value segment combination is randomly generated from the N value segment combinations, and a value segment combination generated each time is not repeated.

In some embodiments, the generating a corresponding random excitation based on the generated value segment combination and a corresponding random seed is specifically as follows:
if a value range of each variable in the value segment combination is a single numerical value, directly returning the value as the random excitation; or if a value range of each variable in the value segment combination is a numerical value range, generating a random value in the numerical value range as the random excitation based on a random seed that is correspondingly set for the value range, so that one random value is obtained for one variable.

In some embodiments, when the weight (weight) is 0, it indicates that a value segment corresponding to the weight (weight) is ignored, and the value segment does not participate in combination; and
when the weight (weight) has a negative sign, the negative sign indicates an invalid combination, and when weights of all value segments in a combination have a negative sign, it indicates that the combination is an invalid combination.

According to another aspect, the present disclosure provides a test system based on a combination function coverage, including:
a construction module, configured to: construct a combination function coverage based on an actual verification requirement, and directly use the combination function coverage as a random constraint to generate a random excitation;
a random seed determining module, configured to set a random seed for a value range of each variable in the combination function coverage structure;
a combination module, configured to generate a value segment combination sequentially or randomly based on a total quantity of scenarios in the combination function coverage structure; and
a test module, configured to generate a corresponding random excitation based on the generated value segment combination and a corresponding random seed, to perform testing.

In some embodiments, the combination module includes a sequential combination unit and a random combination unit;
the sequential combination unit generates a value segment combination sequentially based on the total quantity of scenarios in the combination function coverage structure; and
the random combination unit first generates value segment combinations that cover all scenarios in the combination function coverage structure, and then randomly generates a value segment combination from all the value segment combinations, and a value segment combination generated each time is not repeated.

1. In the present disclosure, a function coverage target is directly used as a random constraint to generate a random excitation. Therefore, a large amount of coding work related to the random constraint is omitted, so that a coding workload is greatly reduced, and coding efficiency is improved. In addition, random data can directly hit a target, especially hit a combination target at a time, which compensates for the lack of a function of a combination constraint in the conventional technology.

2. Compared with conventional definition of the function coverage target, in the present disclosure, a simplified definition structure of the function coverage target is used to implement definition of a single-variable or multi-variable combination function coverage target, which improves a human-computer interaction level, and reduces the coding workload by 2/3. Especially in an actual verification process, hundreds of or thousands of function coverage targets need to be defined, so that the coding workload is greatly reduced.

3. In the conventional technology in which only an overall weight can be set for coverpoint, cross, and covergroup, it only makes sense to calculate overall coverage data, and a verification requirement cannot be reflected. A structure used in the present disclosure can also be used to set a weight for bins, so that the structure better meets an actual verification requirement.

4. In the present disclosure, a random test and a direct test can be further unified, where a single value is subject to the direct test, and a value range is subject to the random test.

### BRIEF DESCRIPTION OF DRAWINGS

The accompanying drawing described herein is used to provide further understanding of embodiments of the present disclosure, and constitutes a part of the present application, but does not constitute limitations to the embodiments of the present disclosure. In the accompanying drawings:

FIG. 1 is a schematic flowchart of a method according to an embodiment of the present disclosure;

FIG. 2 is a schematic block diagram of a computer according to an embodiment of the present disclosure; and

FIG. 3 is a schematic block diagram of a system according to an embodiment of the present disclosure.

### DESCRIPTION OF EMBODIMENTS

To make the objectives, technical solutions and advantages of the present disclosure clearer, the present disclosure is further described in detail below with reference to embodiments and the accompanying drawing. The schematic implementations of the present disclosure and descriptions thereof are only used to explain the present disclosure, but are not intended to limit the present disclosure.

### Embodiment 1

In an existing random test technology based on a function coverage, a function coverage target and a random constraint are separately defined and implemented, which causes a problem that a programming workload is large, test efficiency is low, and 100% coverage cannot be reached. In this embodiment of the present disclosure, a test method based on a combination function coverage is provided. In the test method provided in this embodiment of the present disclosure, a function coverage is defined by using a new structure, and definition of the function coverage is directly used as a random constraint. Therefore, coding work related to definition and implementation of the random constraint is omitted, so that a coding workload of a related person is greatly reduced, and a related random test algorithm is implemented, thereby efficiently implementing a combination function coverage target.

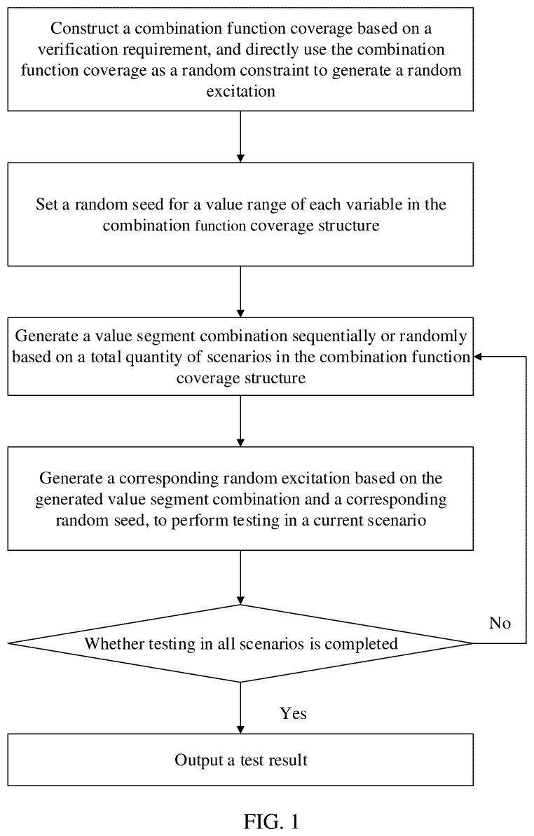

Specifically, as shown in FIG. 1, the test method provided in this embodiment of the present disclosure mainly includes the following steps:

Step 1: Construct a combination function coverage based on a verification requirement, and directly use the combination function coverage as a random constraint to generate a random excitation.

In this embodiment of the present disclosure, the constructed combination function coverage structure is a nested three-level structure in which a first level, a second level, and a third level structure are sequentially arranged from the outside to the inside. Curly brackets “{ }” are used at the first level to indicate related internal elements (coverpoint) and a combination (cross) of the elements, and the first level may include at least one coverpoint element (or variable) inside. The function coverage structure used in this embodiment of the present disclosure is used to combine and unify coverpoint and cross as one category. A cross combination of a single element is coverpoint, that is, coverpoint is a special case of the cross combination, and keywords such as coverpoint and cross may be omitted. The second level is implemented by using square brackets “[ ]” to represent all value segments bins of each internal element coverpoint. A value segment of a variable may be defined by using an integer (including a negative integer, zero, and a positive integer). The third level is implemented by using square brackets “[ ]” to represent a value range of a single value segment. The value range mainly includes two types: The first type is a single numerical value that may also be referred to as a special case of a numerical value range, that is, upper and lower limits of the numerical value range are a same value, and the square brackets may be omitted. The second type is a numerical value range with upper and lower limits, and the square brackets may not be omitted.

bins is a segmented value of a variable. In the chip verification field, there are three types of values for bins:

1. Boundary value: The boundary value is a relative key single value or range, such as 0, 1, 255, [63, 65].

2. Typical value: There are generally a plurality of typical values, and functions of the values are the same. Hitting any one of them is sufficient. Such a typical value may be used to define a range, and implementing random hitting is sufficient, for example, [2, 254].

3. Error value: The error value is, for example, a value or range beyond a range, for example, a divisor is 0, 256, [256, 511]. The error value belongs to abnormal testing, and is used for reliability and robustness testing.

In this embodiment of the present disclosure, definition of the function coverage target is directly used as the random constraint to generate the random excitation to perform random testing, so that coding work related to the random constraint is reduced. In addition, the function coverage target structure used in this embodiment of the present disclosure is more simplified than an existing function coverage target structure, so that coding work can be reduced by more than 80%.

In the function coverage structure of this embodiment of the present disclosure, “*weight” is further used at the third level to set a weight for bins, and the weight is used to represent a repetition quantity of bins corresponding to the weight. In addition, the weight (weight) may alternatively be 0, indicating that a value segment corresponding to the weight is ignored, and the value segment does not participate in a combination. The weight (weight) may have a negative sign, the negative sign indicates an invalid combination, and when weights of all value segments in the combination have a negative sign, it indicates that the combination is an invalid combination. When a weight of one value segment in a combination does not have a negative sign, it indicates that the combination is a valid combination.

Compared with the conventional technology in which only an overall weight is set to calculate coverage data, in this embodiment of the present disclosure, a weight may be directly set for bins, which better meets an actual verification requirement.

In this embodiment of the present disclosure, a specific example is used to describe the function coverage structure in detail.

In the example, two variables are defined. However, this is not limited. In another preferred embodiment, one variable and a combination of a plurality of variables may be supported. Specific code is as follows:

```
cross c1 = {
  // variable x
  [[0, 63] * 2, [64, 127], [128, 191], [192, 255]],
  // variable y
  [0 * 3, [1, 84], [85, 169], [170, 255]]
}
```

It may be learned from the foregoing definition that the example includes two variables (the variable x and the variable y) and a combination thereof, where the variable x has five value segments, the variable y has six value segments, and the two variables are combined to obtain a total of 5×6=30 cases. If five cases are covered, a coverage is 5/30=16.7%.

Step 2: Set a random seed for a value range of each variable in the combination function coverage structure.

In this embodiment of the present disclosure, the random seed is set to subsequently generate a random excitation, and the random seed is set to ensure that a random excitation used in each test can be reproduced.

Step 3: Generate a value segment combination sequentially or randomly based on a total quantity of scenarios in the combination function coverage structure.

In this embodiment of the present disclosure, a total quantity of scenarios in a combination function coverage structure is N=N₁*N₂* . . . *Nn, n represents a quantity of variables, and Nᵢ (i=1, 2, . . . , n) represents a quantity of value segments of an i^{th} variable.

If a value segment combination is generated sequentially, combinations are exhaustively listed based on a combination sequence, and when a weight is encountered, repetition is performed based on the weight. The foregoing combination function coverage structure used in this embodiment of the present disclosure is used as an example for description, that is, the first combination is [[0, 63], 0], the second combination is [[0, 63], 0], the third combination is [[0, 63], 0], and the fourth combination is [[0, 63], [1, 84]]. By analogy, the thirtieth combination is [[192, 255], [170, 255]].

If a value segment combination is generated randomly, N value segment combinations are first obtained, and the N value segment combinations cover all scenarios in the combination function coverage structure, that is, the N value segment combinations are not repeated, thereby implementing 100% coverage of the cross combination. Then, a value segment combination is randomly generated from the N value segment combinations, and the value segment combination generated each time is not repeated with a value segment combination generated previously.

Step 4: Generate a corresponding random excitation based on the generated value segment combination and a corresponding random seed, to perform testing in a current scenario.

In this embodiment of the present disclosure, if a value range of each variable in the value segment combination is a single numerical value, the value directly returned as the random excitation; or if a value range of each variable in the value segment combination is a numerical value range, a random value in the numerical value range is generated as the random excitation based on a random seed that has been set, so that one random value is obtained for one variable.

Step 5: Determine whether testing in all scenarios in the combination function coverage structure is completed; and if yes, output a test result; otherwise, return to step 3.

Compared with a conventional test technology, in this embodiment of the present disclosure, the combination function coverage target structure is directly used as a random constraint, and in a random excitation generation process, 100% coverage of a combination in the combination function coverage is ensured, so that the combination function coverage target can be quickly and efficiently implemented, and the coverage reaches 100%.

In this embodiment of the present disclosure, the foregoing combination function coverage structure is used as an example for detailed description. A direct combination manner in step 3 is encapsulated as a directCross( ) function, and a random combination manner in step 3 is encapsulated as a random( ) function. The directCross( ) function or the random( ) function can be invoked 30 times to generate 5×6=30 groups of random data for x and y, and all combination cases may be completely hit. Code is specifically as follows:

| | |
|---|---|
| list<int>rand_data | |
| int i | |
| for i [1, 30, 1]: | |
| rand_data=c1. directCross( ) | // direct combination manner |
| list<int>rand_data | |
| int i | |
| for i [1, 30, 1]: | |
| rand_data=c1. random( ) | // random combination manner |

In this embodiment of the present disclosure, a random test (Random Test) and a direct test (Direct Test) are unified. An only difference between the random test and the direct test lies in whether the generated random data is a single fixed value or any random value in a numerical value range.

In a cross data structure, [1, 100] represents a value range, and 25 or [25, 25] represents a single fixed value. Both are unified in form, and the fixed value may be considered as a special case of a value range. In this way, the random test and the direct test can be unified by simply changing magnitude of start and end data in the value range.

An embodiment further provides a computer device, configured to perform the foregoing method in this embodiment.

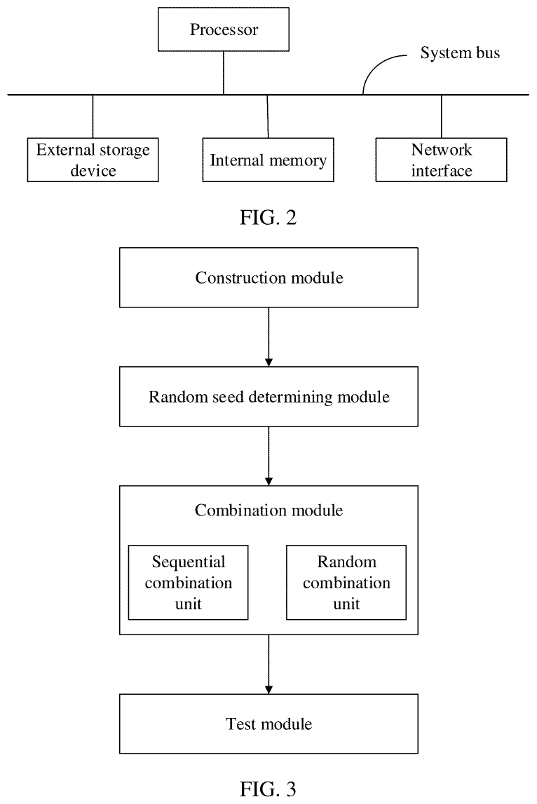

Specifically, as shown in FIG. 2, the computer device includes a processor, an internal memory, and a system bus. Various device components, including the internal memory and the processor, are connected to the system bus. The processor is hardware configured to execute a computer program instruction by using a basic arithmetic and logical operation in a computer system. The internal memory is a physical device for temporarily or permanently storing a computing program or data (for example, program status information). The system bus may be any one of the following several types of bus structures, including a memory bus or a storage controller, a peripheral bus, and a local bus. The processor and the internal memory may perform data communication by using the system bus. The internal memory includes a read-only memory (ROM) or a flash memory (not shown in the figure), and a random access memory (RAM). The RAM is generally a main memory loaded with an operating system and a computer program.

The computer device generally includes an external storage device. The external storage device may be selected from a plurality of computer-readable media. The computer-readable medium is any available medium that can be accessed by using the computer device, including two types of media: a mobile medium and a fixed medium. For example, the computer-readable medium includes but is not limited to a flash memory (micro SD card), a CD-ROM, a digital versatile disc (DVD) or another optical disc storage, a magnetic tape cassette, a magnetic tape, a magnetic disk storage, or another magnetic storage device, or any other medium that may be used to store required information and that can be accessed by the computer device.

The computer device may be logically connected to one or more network terminals in a network environment. The network terminal may be a personal computer, a server, a router, a smartphone, a tablet computer, or another public network node. The computer device is connected to the network terminal through a network interface (local area network LAN interface). The local area network (LAN) is a computer network that is interconnected in a limited area, such as a home, a school, a computer laboratory, or an office building that uses network media. Wi-Fi and twisted pair cabling Ethernet are the two most commonly used technologies for constructing LAN.

It should be noted that another computer system including more or fewer subsystems than the computer device may also be applicable to the present disclosure.

As described in detail above, the computer device applicable to this embodiment can perform specified operations of the test method based on a combination function coverage. The computer device performs these operations by running software instructions in the computer-readable medium by using the processor. These software instructions may be read into a memory from a storage device or from another device through a local area network interface. The software instructions stored in the memory cause the processor to perform the foregoing test method based on a combination function coverage. In addition, the present disclosure may also be implemented by using a hardware circuit or a hardware circuit in combination with software instructions. Therefore, implementation of this embodiment is not limited to a combination of any specific hardware circuit and software.

### Embodiment 2

An embodiment of the present disclosure provides a test system based on a combination function coverage. As shown in FIG. 3, the test system in this embodiment of the present disclosure includes:
a construction module, configured to: construct a combination function coverage based on an actual verification requirement, and directly use the combination function coverage as a random constraint to generate a random excitation, where the constructed combination function coverage structure in this embodiment of the present disclosure is the same as that in the foregoing Embodiment 1, and details are not described herein again;
a random seed determining module, configured to set a random seed for a value range of each variable in the combination function coverage structure;
a combination module, including a sequential combination unit and a random combination unit, where the sequential combination unit generates a value segment combination sequentially based on a total quantity of scenarios in the combination function coverage structure; and the random combination unit generates a value segment combination randomly based on a total quantity of scenarios in the combination function coverage structure; and
a test module, configured to generate a corresponding random excitation based on the generated value segment combination and a corresponding random seed, to perform testing.

The objectives, technical solutions, and beneficial effects of the present disclosure are further described in detail in the above specific implementations. It should be understood that the above described are only specific implementations of the present disclosure and are not intended to limit the protection scope of the present disclosure. Any modification, equivalent replacement, improvement, and the like made within the spirit and principle of the present disclosure should fall within the protection scope of the present disclosure.

1. A test method based on a combination function coverage, comprising:
constructing a combination function coverage based on a verification requirement, and directly using the combination function coverage as a random constraint to generate a random excitation;
setting a random seed for a value range of each variable in the combination function coverage structure;
generating a value segment combination sequentially or randomly based on a total quantity of scenarios in the combination function coverage structure;
generating a corresponding random excitation based on the generated value segment combination and a corresponding random seed, to perform testing in a current scenario; and
determining whether testing in all scenarios in the combination function coverage structure is completed, and if testing in all the scenarios in the combination function coverage structure is not completed, returning to the step of generating a value segment combination sequentially or randomly based on a total quantity of scenarios in the combination function coverage structure.

2. The test method based on a combination function coverage according to claim 1, wherein the constructed combination function coverage structure is a nested three-level structure in which a first level, a second level, and a third level are sequentially arranged from the outside to the inside;
curly brackets “{ }” are used at the first level to indicate related internal variables and a combination of the variables;
square brackets “[ ]” are used at the second level to indicate all value segments of each variable; and
square brackets “[ ]” are used at the third level to indicate a value range of each value segment.

3. The test method based on a combination function coverage according to claim 2, wherein the first level comprises at least one variable.

4. The test method based on a combination function coverage according to claim 2, wherein the value range of each value segment comprises two types, one type is a single numerical value, that is, upper and lower limits of the value range are a same value, and the other type is a value range using upper and lower limits, that is, the upper and lower limits of the value range are different values.

5. The test method based on a combination function coverage according to claim 4, wherein when the value range is a single numerical value, the square brackets “[ ]” are omitted.

6. The test method based on a combination function coverage according to claim 2, wherein the third level further comprises “*weight” added after the square brackets “[ ]” of each value range, weight represents a weight, and the weight is used to represent a repetition quantity of a value corresponding to the value range.

7. The test method based on a combination function coverage according to claim 1, wherein the generating a value segment combination sequentially or randomly based on a total quantity of scenarios in the combination function coverage structure is specifically as follows:
a total quantity of scenarios in a combination function coverage structure is N=N₁*N₂* . . . *Nn, n represents a quantity of variables, and Nᵢ (i=1, 2, . . . , n) represents a quantity of value segments of an i^{th} variable; and
if a value segment combination is generated sequentially, combination is performed sequentially based on the quantity N of scenarios, and when a weight is encountered, repetition is performed based on the weight; or
if a value segment combination is generated randomly, N value segment combinations that cover all scenarios in the combination function coverage structure are first generated based on the quantity N of scenarios, then a value segment combination is randomly generated from the N value segment combinations, and a value segment combination generated each time is not repeated.

8. The test method based on a combination function coverage according to claim 1, wherein the generating a corresponding random excitation based on the generated value segment combination and a corresponding random seed is specifically as follows:
if a value range of each variable in the value segment combination is a single numerical value, directly returning the value as the random excitation; or if a value range of each variable in the value segment combination is a numerical value range, generating a random value in the numerical value range as the random excitation based on a random seed that is correspondingly set for the value range, so that one random value is obtained for one variable.

9. The test method based on a combination function coverage according to claim 6, wherein when the weight is 0, it indicates that a value segment corresponding to the weight is ignored, and the value segment does not participate in combination; and
when the weight has a negative sign, the negative sign indicates an invalid combination, and when weights of all value segments in a combination have a negative sign, it indicates that the combination is an invalid combination.

10. A test system based on a combination function coverage, comprising:
a construction module, configured to: construct a combination function coverage based on an actual verification requirement, and directly use the combination function coverage as a random constraint to generate a random excitation;
a random seed determining module, configured to set a random seed for a value range of each variable in the combination function coverage structure;
a combination module, configured to generate a value segment combination sequentially or randomly based on a total quantity of scenarios in the combination function coverage structure; and
a test module, configured to generate a corresponding random excitation based on the generated value segment combination and a corresponding random seed, to perform testing.

11. The test system based on a combination function coverage according to claim 10, wherein the combination module comprises a sequential combination unit and a random combination unit;
the sequential combination unit generates a value segment combination sequentially based on the total quantity of scenarios in the combination function coverage structure; and
the random combination unit first generates value segment combinations that cover all scenarios in the combination function coverage structure, and then randomly generates a value segment combination from all the value segment combinations, and a value segment combination generated each time is not repeated.
